(19) United States
(12) Patent Application Publication
(10) Pub. No.: US 2019/0035045 A1
(43) Pub. Date: Jan. 31, 2019

(54) System and Method for Securing Commercial Retail Tenants

(71) Applicant: Yuri Spiro, Beverly Hills, CA (US)

(72) Inventor: Yuri Spiro, Beverly Hills, CA (US)

(21) Appl. No.: 15/727,798

(22) Filed: Oct. 9, 2017

Related U.S. Application Data
(60) Provisional application No. 62/537,666, filed on Jul. 27, 2017.

(51) Int. Cl. G06Q 90/00; A63F 13/25; A63F 13/80

(52) U.S. Cl. CPC G06Q 90/00; A63F 2250/64; A63F 13/80; A63F 13/25

(57) ABSTRACT

A system and method for use by commercial landlords seeking to lease retail space to commercial tenants utilizing a contest whereby potential lessees compete in a series of challenges designed to reveal the most desirable tenant.

### RELATED APPLICATIONS

This Application claims the benefit of priority under 35 U.S.C. 119(e) of Provisional Application No. 62/537,666, filed Jul. 27, 2017. The provisional application is incorporated by reference herein in its entirety.

### BACKGROUND OF THE INVENTION

### 1. Field of the Invention

The present invention generally pertains to methods for securing commercial lease tenants—primarily in the retail store category—by landlords seeking to choose among potential tenants those tenants and businesses that are most likely to succeed in the commercial space available.

### 2. Description of the Prior Art

Previously, commercial tenants of retail store spaces scrutinized various objective and subjective criteria in determining whether a proposed tenant was a “good fit.” Those criteria usually included the proposed lessee's financial plan, financial wherewithal, credit history, and previous success in the retail marketplace. Also considered was whether the proposed lessee's product line or services to be provided at the location were suitable for the location. These methods often fell short however as they rely ultimately on a subjective analysis of the information provided. What is needed therefore is a system and method for screening and selecting the best commercial tenant for a retail space.

A search of the prior art did not disclose any patents that possess the novelty of the instant invention, however the following U.S. patent is considered related: U.S. Pat. No. 8,706,604 to Topitzer discloses a method for hedging risks of tenant default on a lease agreement by offering the landlord a “put” option based on the risk of such default. While this method does involve an analysis of the potential tenant's success and provides a hedge against failure of a tenant to pay, it does not provide the landlord with an active and “live” comparison between potential tenants and their business activities in the landlord's location. What is needed therefore is a method and system whereby a landlord can screen potential tenants by providing potential tenants an opportunity, via a series of competitions with other potential tenants, to demonstrate their business's worthiness as a retail tenant in the landlord's retail location.

### SUMMARY OF THE INVENTION

The present invention is designed to assist commercial property owners who have retail space for lease to select the best tenants for their property. The method and system described herein is in the form generally of a contest among entrepreneurs (or teams of entrepreneurs) who wish to establish a retail location for their product or service. Each group will begin with a pitch to the landlord detailing the group's reason for the choosing the landlord's location, the product and service to be offered and the marketing plan to be employed. The landlord will then select a number of potential tenants from these groups. The landlord will then allow each potential tenant a set period of time to prepare the retail location for an opening sales weekend. During this time, the potential tenants will also prepare a marketing and promotion campaign geared to attracting customers to their opening sales weekend at the location. During this process, the landlord will observe and monitor the activities of each of the potential tenants with an eye to evaluating each prospective tenant's business acumen and the appropriateness of each prospective tenant's marketing plans with the landlord's retail location.

When preparations are complete, each prospective tenant will conduct an opening sales weekend whereby the prospective tenant will set up their retail store at the landlord's location and open for business for a short period of time. When each prospective tenant has completed its opening sales weekend, the landlord will then tally the sales results for each prospective tenant.

Thereafter, the landlord will analyze the data collected. This will include the landlord's assessment of the prospective tenant's pitch session, the landlord's assessment of each prospective tenant's product or service, its marketing and promotion campaign and the results of the opening sales weekend. Based on this assessment of data, the landlord can make an effective choice regarding the best tenant for the location.

### BRIEF DESCRIPTION OF THE DRAWINGS

FIG. 1 is a schematic diagram of the elements that comprise the system and method of the invention

### DETAILED DESCRIPTION OF THE INVENTION

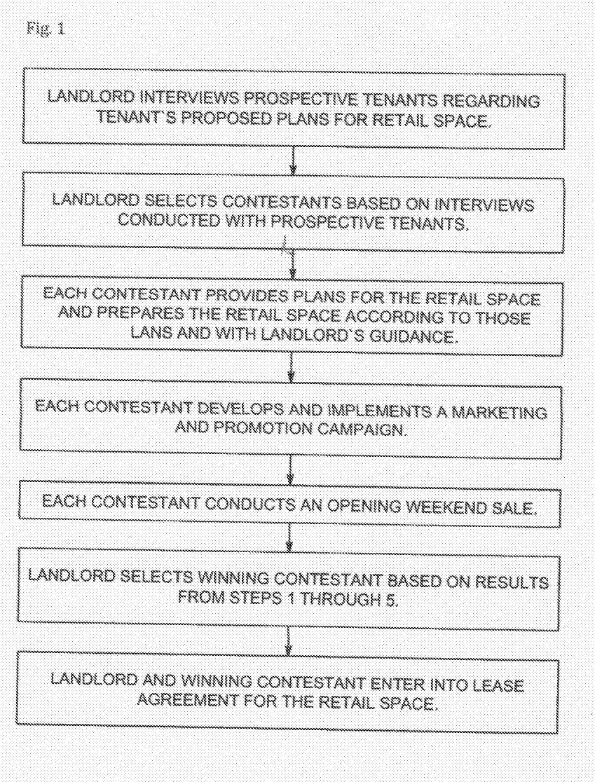

The method and system described herein is in the form of a contest among potential tenants of a retail location whereby the contest presents various challenges to each prospective tenant surrounding the preparation of a retail store location, marketing of the prospective tenant's product or service and the promotion of a opening sales weekend for the sales of the prospective tenant's product or service to the consuming public. Referring to FIG. 1, the first step in the method and system of this invention is for the landlord or property owner to assess a group of prospective tenants by interviewing each prospective tenant and having each prospective tenant provide a pitch to the landlord regarding the prospective tenant's product or service and its plans for the retail location in question. This first step is designed as a preliminary screen of potential tenants and to provide the landlord with a group of prospective tenants that he feels may be well suited for the particular retail space. Ideally, a landlord will select at least 3-4 prospective tenants—illustrated as Step 2 in FIG. 1—to properly assess them in the following steps of the method.

After the landlord has selected a group of prospective tenants, now referred to as “contestants”, the landlord will task each contestant with preparing the retail location to serve as each contestant's storefront. This is shown as Step 3 in FIG. 1. The landlord will inform each contestant of the amount to be budgeted—which, in a preferred embodiment, can be advanced by the landlord—for preparing the storefront with signage and other fixtures. The budget should be fixed and the same amount for each contestant. This is so the landlord can properly assess the ability of each contestant to maximize the utility of the amount provided to it for purposes of dressing the retail space. It is expected that each contestant will take into account any special permitting issues and required renovations that the contestant's plan requires. Ideally though, the emphasis will remain on identifying which contestant can do the most with the little amount each has. Although, it is understood that, in other embodiments, the landlord may permit a variety of amounts to be budgeted for each contestant depending on the type of product or service. Also during this time, it is anticipated that the landlord will provide a resource to each contestant, lending guidance and suggestions to the contestants based on his or her expertise and experience with the location. After completion of this task, the landlord will judge each contestant's fully prepared storefront.

Referring again to FIG. 1, step 4, the next task for each contestant is to prepare a marketing and promotional campaign for their product or service in connection with an “opening weekend sale” to be held at the retail location. Again, the budget for each contestant will be set by the landlord and, ideally, provided and/or advanced by the landlord. In other embodiments, depending on preferences of the landlord, the landlord can severely limit the budget, do away with a budget all-together, or provide other parameters with respect to the type of promotional campaign permitted, for example, a social media campaign, flyers, or specific types of advertising. In another embodiment, the landlord can allow each contestant to supply its own budget as it sees fit, but then factor the budget into the landlord's judging decision.

Referring again to FIG. 1, step 5, each team will then be open for business for an Opening Sales Weekend. This can be a three-day weekend and can be open any hours that the team chooses. During this time, the team will manage the retail sales operation. The team can hire retail sales personnel or handle it themselves depending what they see fit. The landlord will employ secret shoppers and real customer reviews to gauge customer service and other elements of the retail experience. The landlord will utilize these factors in determining the winner. At the end of the Sales Weekend, the revenues generated will also be analyzed by the landlord in their selection of a winning team.

The winning team will be selected by the landlord as shown in Step 6 of FIG. 1. In so doing, the landlord will review and analyze the various factors that emerged during the previous 5 steps. These factors will include the product chosen by the contestant, the contestant's marketing and promotion activities, the sales revenue generated during the opening sales weekend, the entrepreneurial spirit and skills of the contestant and its team, and an overall impression of the chances of retail success. It is understood that the landlord can employ or enlist other professionals to assist with the judging of the factors and selection of the winning contestant.

The winning contestant is permitted to lease the premises, as shown in Step 7 of FIG. 1. This would occur in the traditional fashion, namely with the winning contestant, now tenant, signing a lease agreement for the very premises in which it conducted its successful opening weekend sale. Alternatively, the winning contestant may be awarded an investment by landlord in the form of a subsidized lease of the retail storefront location.

Alternatively, the winning contestant and landlord could form a partnership with the landlord whereby the landlord contributes the premises, or a discounted lease on the premises, or some other contribution to the retail operation.

It is understood that the system and method described above may be variously implemented and variously used depending upon specific applications. Accordingly, the scope hereof shall not be referenced to the disclosed embodiments, but on the contrary, shall be determined in accordance with the general definitions assigned to the terms herein.

1. A method for selecting a tenant for a commercial space comprising the steps of: interviewing prospective tenants regarding their proposed commercial operation; selecting prospective tenants to compete as contestants in a series of challenges; providing each said contestant with a series of challenges; evaluating each said contestant's performance regarding the said series of challenges; selecting a winning tenant for the said commercial space from among the said contestants based on said evaluation of said performance; and leasing said commercial space to said winning tenant.

2. The method of claim 1 wherein the said challenges include: requiring said contestants to provide a marketing plan for the said proposed commercial operation; to provide a proposed design for the said commercial space; and to conduct a trial retail-sales operation in the said commercial space.

3. The method of claim 1 further comprising the step of: recording the steps of said method for selecting tenants for broadcast as a reality-based television program.

4. The method of claim 1 wherein the selection of the winning tenant is made by at least one person.

5. The method of claim 1 further comprising the step of: forming a partnership with said winning tenant for said use of the commercial space.
